(19) United States
(12) Patent Application Publication
(10) Pub. No.: US 2003/0214136 A1
(43) Pub. Date: Nov. 20, 2003

(54) Slidable closure for a pivoting cover

(76) Inventors: Hans-Joachim Dembowsky, Hamburg (DE); Rainer Sussenbach, Steinhagen (DE); Wolfgang Hesse, Rietberg (DE)

Correspondence Address: SEYFARTH SHAW, 55 EAST MONROE STREET, SUITE 4200, CHICAGO, IL, 60603-5803, US

(21) Appl. No.: 10/272,826

(22) Filed: Oct. 17, 2002

(30) Foreign Application Priority Data
May 15, 2002 (DE) 102 21 645.2

(51) Int. Cl. E05C 1/10

(52) U.S. Cl. 292/175

(57) ABSTRACT

A slidable closure for a pivoting cover of a storing compartment in a vehicle. The slidable closure comprises an integral one-piece plastic member comprising a closure member and a resiliently deformable spring member. The closure member has a gripping portion, a catch and a flange. The slidable closure when mounted within an opening of the pivoting cover, is slidably guided by the flange slidably engaging one side of the pivoting cover and by the catch and the spring member slidably engaging the other side of the pivoting cover, such that the closure member is slidably displaceable relative to a fixedly supported end of the spring member in a longitudinal direction between opening and closing positions.

### BACKGROUND

The present invention relates to a slidable closure for a pivoting cover of a storing compartment in a vehicle.

Storing compartments are provided for example in walls of a vehicle such as in the sidewalls of a trunk area. Such a storing compartment generally is closed by a cover or flap which is pivotally mounted to a wall of a storing compartment by hinge means or by simple pin connecting means. The pivoting cover is secured in its closing position by a pivoting or slidable closure which can be manually unlocked so that the pivoting cover may be moved to its opening position.

There is a great number of different designs of such pivoting and slidable closures. Generally they consist of a plurality of separate members causing substantial manufacturing costs. Furthermore, it is generally necessary to fix a mounting member of a slidable closure to the pivoting cover by separate securing elements so that mounting of the slidable closure to the pivoting cover is time consuming and expensive. Quite often at least some parts of the slidable closure are made of metal, which is not desirable for manufacturing cost, total weight and waste disposal reasons. Furthermore, handling and actuation of some of the prior art closures are complex and difficult.

### SUMMARY

It is a primary object of the present invention to provide a slidable closure for a pivoting cover of a storing compartment in a vehicle, which requires minimal manufacturing and mounting expenditure and which can be handled and actuated in an extremely simple manner.

It is a further object of the present invention to provide such a slidable disclosure which does not tend to rattle or chatter during operation of the vehicle.

The slidable closure of the present invention comprises a closure member having a gripping portion for actuating the slidable closure, a catch integrally connected to said gripping portion and a flange integrally connected to the gripping portion, and a resiliently deformable spring member having an end integrally connected to the closure member and an opposite free end adapted to be fixedly supported against the pivoting cover. The closure member and the spring member are formed as an integral one-piece member which, when mounted within an opening of the pivoting cover, is guided without play by the flange slidingly engaging one side of the pivoting cover and the catch and the spring member being resiliently supported on an opposite side of the pivoting cover such that the closure member is displaceable in a longitudinal direction relative to the fixedly supported free end of the spring member between a closing position wherein the catch engages behind a retaining tongue at a fixed wall of the storing compartment, and an opening position wherein the catch may be moved past said retaining tongue so that the pivoting cover may be opened. During such longitudinal displacement of the closure member the spring member will be resiliently deformed.

As indicated above the slidable closure consists of an integral one-piece member which preferably is a casting of an impact resistant, resiliently deformable plastic material. Therefore, the slidable closure can be manufactured in a very simple manner by injection molding so that the slidable closure is suited for mass production. The slidable closure may be inserted into the opening of the pivoting cover either directly or via a separate frame. In each case no special securing elements for mounting the slidable closure to the pivoting cover are required. Therefore, mounting of the slidable closure to the pivoting cover is extremely simple.

The slidable closure may be opened by a simple manual push or pull movement. To this end the gripping portion may be formed as a trough-shaped member which is recessed to facilitate engagement thereof by fingers of a hand. As a result thereof the gripping portion enables not only actuation of the slidable closure but also pivoting of the pivoting cover. The slidable closure is automatically moved to its closing position when it is being closed.

### BRIEF DESCRIPTION OF THE DRAWINGS

For the purpose of facilitating an understanding of the mounting arrangement, there is illustrated in the accompanying drawings a preferred embodiment thereof, from an inspection of which, when considered in connection with the following description, the mounting arrangement, its construction and operation, and many of its advantages should be readily understood and appreciated.

FIG. 1 is a longitudinal section of a slidable closure mounted to a pivoting cover, with the slidable closure and the pivoting cover being in their closing positions;

FIG. 2 is a longitudinal section of a slidable closure similar to FIG. 1, whereas the slidable closure is in its opening position and the pivoting cover is partially opened;

FIG. 3 is a longitudinal section of the slidable closure by itself;

FIG. 4 is a top view of the slidable closure in FIG. 3;

FIG. 5 is a rear view of the slidable closure in FIG. 3;

FIG. 6 is a front view of the slidable closure in FIG. 3;

FIG. 7 is a bottom view of a frame for the slidable closure of FIGS. 3 to 6;

FIG. 8 is a sectional view in the direction of arrows VIII-VIII in FIG. 7;

FIG. 9 is a side elevation of the frame in FIG. 7,

FIG. 10 is a schematic view of the opening of the pivoting cover indicated by dash-dotted lines;

FIGS. 11, 12 are sectional views of the frame similar to FIG. 8 and showing the frame during assembly with the pivoting cover;

FIG. 13 is a side elevation, partially in section, of the slidable closure while being mounted to the frame inserted into the pivoting cover;

FIG. 14 is a view similar to FIG. 13 after assembly;

FIG. 15 is a view similar to FIG. 13 of the slidable closure while being mounted directly to the pivoting cover without the use of any frame.

### DETAILED DESCRIPTION

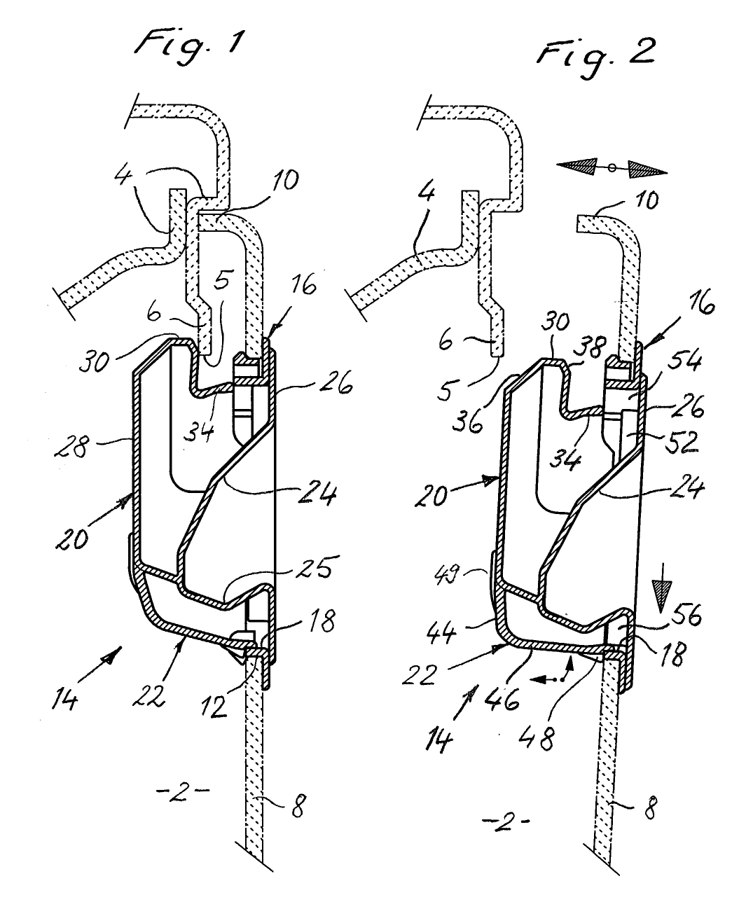

Referring to FIGS. 1 and 2, a storing compartment 2 is defined by walls 4 and an access opening 5. The storing compartment may be for example a storing compartment in a sidewall of a vehicle in the trunk area thereof. However, as will be readily apparent, the invention is not limited to such an application. The access opening 5 of the storing compartment 2 has associated therewith a pivoting cover or flap 8 which has one end engage the wall 4 so as to be pivoting about a (not shown) pivoting axis (as indicated by opposed arrows in FIG. 2) and has a deflected end 10 engage the wall 4, such that the pivoting cover 8 is spaced from a retaining tongue 6 at the wall 4 by a predetermined distance (see FIG. 1).

For locking the pivoting cover 8 in its closing position (FIG. 1) there is provided a slidable closure 14 which is inserted into an opening 12 of the pivoting cover 8. More precisely, the slidable closure 14 is inserted into an opening 18 of a frame 16 which is inserted into the opening 12 of the pivoting cover 8.

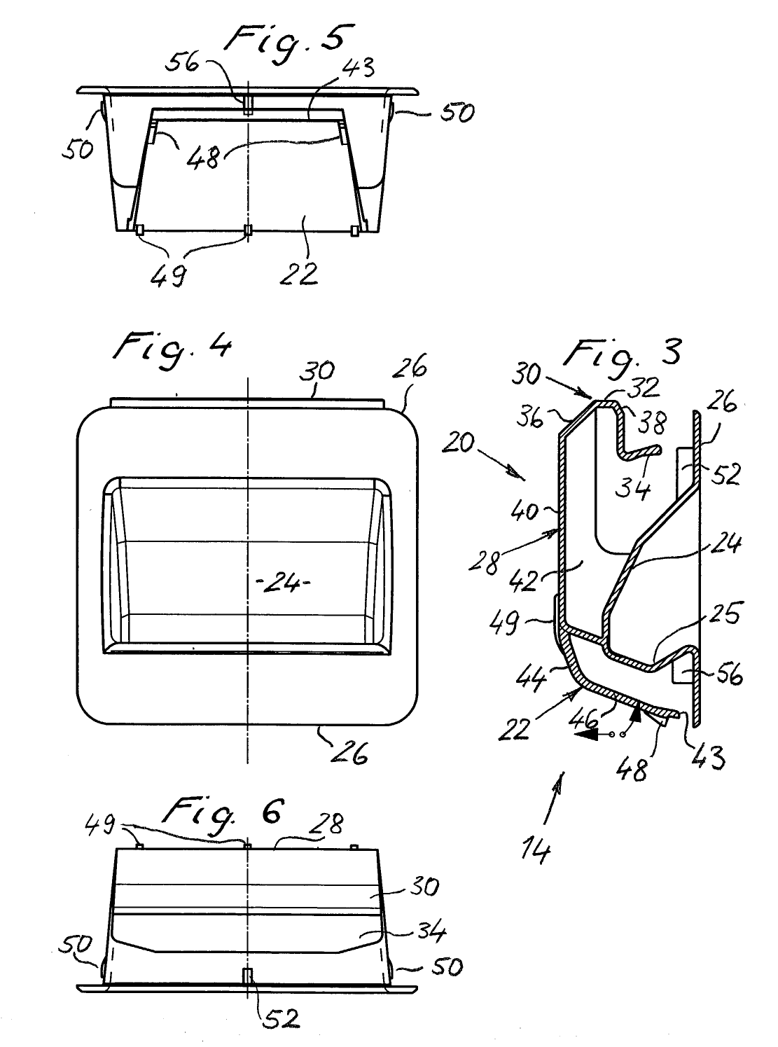

The slidable cover 14 consists of an integral one-piece member which is shown in FIGS. 1 and 2 when mounted to the pivoting cover 8 and in FIGS. 3 to 6 when it is dismounted therefrom. The integral one-piece member forming the slidable closure 14 is made of an impact resistant resiliently deformable plastic material and may be manufactured by injection molding. The plastic material should be sufficient resilient to provide for resiliency of some of the parts of the slidable closure 14 as will be explained in more detail below. As is shown in the drawings, the integral one-piece plastic member of the slidable closure 14 is made up of a plurality of thin-walled portions as will now be described in more detail.

Generally, the slidable closure 14 consists of a closure member 20 and a spring member 22 integrally with each other (see in particular FIG. 3). The closure member 20 comprises a gripping portion 24, a flange 26, a connecting portion 28 and a catch 30.

The gripping portion 24 is formed as a trough-shaped grip, the open side of which is surrounded by the flange 26 extending circumferentially thereabout (see also FIG. 4). The through-shaped grip is provided with a recessed portion 25 so that fingers of a hand of an operator can engage into the trough-shaped grip to exert a force upon the gripping portion 24 both parallel to the plane of the flange 26 and perpendicularly thereto. The shape and dimensions of the gripping portion can be selected as required.

The planar flange 26 surrounding the trough-shaped grip can be used as a symbol surface including a symbol or pictograph for articles to be stored in the storing compartment 2.

The catch 30 is connected to the gripping portion 24 by the connecting portion 28 which is integrally connected to the rear side of the gripping portion 24 and extends therefrom substantially parallel to the plane of the flange 26. As shown in particular in FIG. 3, the catch 30 comprises an arcuately shaped locking portion 32 and a free end portion 34 integrally connected thereto and extending substantially transversely to the plane of the flange 26. The locking portion 32 has, on opposite sides, inclined cam surfaces 36 and 38 which slide along the retaining tongue 6 when the pivoting cover 8 is being closed as will be explained in more detail below.

The locking portion 28 comprises a wall 40 extending substantially parallel to the plane of the flange 26 and a central web 42 extending substantially perpendicularly with respect thereto. The wall 40 and the web 42 have forward ends integrally connected to the locking portion 32 and have rear ends integrally connected to the rear side of the gripping portion 24. This results in a substantially rigid connection between the gripping portion 24 and the connecting portion 28 as well as between the connecting portion 28 and a part (cam surface 36) of the locking portion 32, whereas the other part (cam surface 38) of the locking portion 32 and in particular the free end portion 34 of the catch 30 are adapted to be resiliently moved relative to the connecting portion 28, i. e. in a direction substantially transverse to the plane of the flange 26.

The spring member 22 comprises a spring blade having a front end integrally connected to the wall 40 of the connecting portion 26 and inclined with respect to the wall 40 and having a rear end 43 which is free and spaced from the flange 26 by a predetermined distance (FIG. 3). The spring blade of the spring member 22 has a first leg portion 44 merging into the wall 40 of the connecting portion 26, and a second leg portion 46 which is connected to the first leg portion 44 by a radiussed portion. The second leg portion 46 of the spring member 22 has, adjacent to its free end 43, a pair of wedge-shaped lugs 48 (see also FIG. 5) which are adapted to fixedly support the spring member 22 at a rear end of the opening 18 of frame 16 and to center the spring member 22 within the opening 18 of the frame 16 (see FIGS. 1 and 2). Stiffening ribs 49 may be provided in the area where the wall 40 of the connecting portion 28 and the leg portion 44 of the spring member 22 merge (see also FIGS. 5 and 6).

As is shown in FIGS. 1 to 3, the leg portions 44 and 46 of the spring member 22 are inclined with respect to the plane of the wall 40 under different angles. The leg portion 44 is inclined to the wall 40 under an angle of e.g. about 20° while the leg portion 46 is inclined to the wall 40 under an angle of e.g. about 70°. The purpose of this design of the spring member 22 will be explained in more detail below.

The desired resiliency of the spring membe 22 is a result of the geometric shape on the one hand and of the selected impact-resistent plastic material on the other hand, which plastic material should be sufficiently resilient and of respective elongation and recovery capacity. To provide for optimal uniform distribution of bending stresses in the spring member 22 during resilient deformation thereof, the leg portion 44 is of a wall thickness in excess of that of leg portion 46. More precisely, the leg portion 44 is of a wall thickness which is maximal at the transition between the leg portion 44 and the connecting portion 28 and gradually decreases towards the leg portion 46 as indicated in FIG. 3. As an alternative or additional measure the width of the leg portion 46 may decrease towards the free end 43 as shown in FIG. 5.

When, as shown in FIGS. 1 and 2, the slidable closure 14 has been inserted into the opening 18 of the frame 16, the flange 26 engages an outer surface of the frame 16. The rear end 43 of the spring member 22 is, as already mentioned, fixedly supported on the opposite side of the frame 18 by means of the lugs 48. At the front end of the slid-able closure 14, the free end portion 34 of the catch 30 slidably engages the interior surface of the frame 16. The spring member 22 and the catch 30 are biassed such that the closure member 14 is resiliently supported against the pivoting cover 8 at the front end of the catch 30 and at the rear end of the spring member 22. Engagement of the flange 26 on one side of the pivoting cover 8 and resilient support of the catch 30 and the spring member 22 on the other side of the pivoting cover 8 provide for guidance of the closure member 20 without backlash or play, such that the closure member 20 including the flange 26, the connecting portion 28 and the catch 30 may be slidably displaced relative to the fixed support of the rear end 43 of the spring member 22 in a longitudinal direction, as may be seen in particular by comparing FIGS. 1 and 2. Resilient support of the slidable closure via the catch 30 and the spring member 22 allows for compensation of manufacturing tolerances in the thickness of the walls of the pivoting cover 8 and, respectively, the frame 16.

Resilient support of the closure member 14 via the catch 30 and the spring member 22, as already mentioned, provides for backlash-free or playless guidance of the closure member 20 in a “vertical” direction, i. e. perpendicularly to the plane of the pivoting cover 8 and, respectively, the flange 26. In order to provide for lateral guidance of the closure member 20 within the opening 18 of the frame 16 so as to prevent pivoting or jamming thereof within the relatively wide opening 18, there is provided an arrangement which may be termed as a three-point-bearing. The three-point-bearing includes a pair of lateral guiding projections 50 provided on the external sides of the gripping portion 24 adjacent the opening 18 (see FIGS. 5 and 6), and a central guiding web 52 provided at the front end of the gripping portion 24 in the transitional area between the gripping portion 24 and the flange 26. The guiding web 52 is guided within a guiding groove 54 which is provided adjacent the front edge of the frame 16 (see FIG. 7). The central guiding web 52 furthermore serves as an abutment for limiting longitudinal movements of the closure member 20 towards the closing position (FIG. 1). A central abutment rib 56 at the rear end of the gripping portion 24 in the transitional area between the gripping portion 24 and the flange 26 (see FIGS. 3 and 5) serves as an abutment for limiting longitudinal movements of the closure member 20 in the opposite direction, i. e. towards the opening position (FIG. 2).

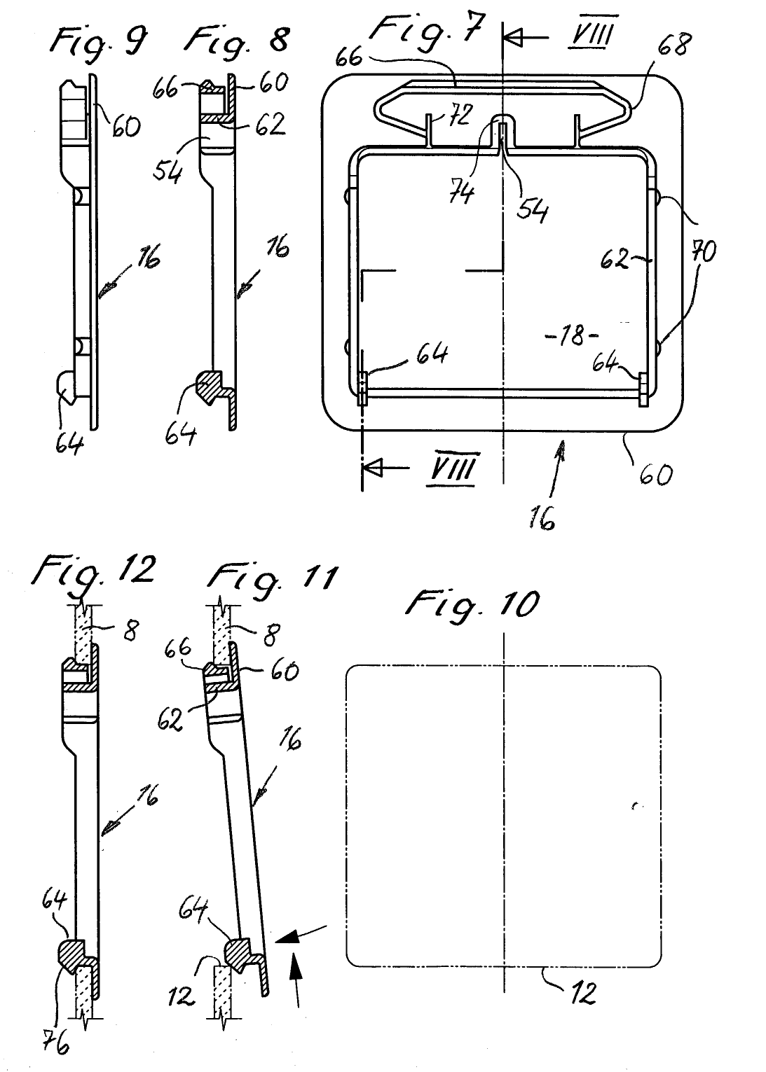

The frame 16, which is shown in more detail in FIGS. 7 to 9, is an integral one-piece member which may be made of the same plastic material as the slidable closure 14. The frame 16 comprises a flange 16 and a web 62 extending transversely thereto and circumscribing the opening 18. The web 62 may be inserted into the opening 12 of the pivoting cover 8, with the frame 16 being retained in the pivoting cover 8 only by snapping means. The snapping means comprise a pair of hooks 64 disposed on opposite sides adjacent the rear end of the frame 16, and a resilient elongated snapping member 66 which is resiliently connected to the web 62 via a pair of spring arms 68 at the front end of the frame 16. The spring arms 68 are integrally connected to a pair of web portions 72 which extend from the web 62 in the longitudinal direction. The guiding groove 54 at the front end of the frame 16 is provided by an U-shaped leg portion 74 which is also integrally connected to the web 62.

The frame 16 and in particular the distance between the hooks 64 and the elongated snapping member 66 are designed and dimensioned such that the frame 16 may be snapped into the periphery of the opening 12 as indicated in FIG. 10 by dash-dotted lines. As shown, the opening is in the shape of a rectangle, the length of which is generally similar to the width thereof; in other words the opening may be a square opening. To provide for playless and tight seating of the frame 16 within the opening 12 also in lateral directions, the web 62 is provided on its outside adjacent the lateral edges of the opening 18 with dimples or nobs 70 which may be press-fitted within the opening 12. The dimples or nobs 70 provide also for compensation of manufacturing tolerances between the opening 12 and the frame 16.

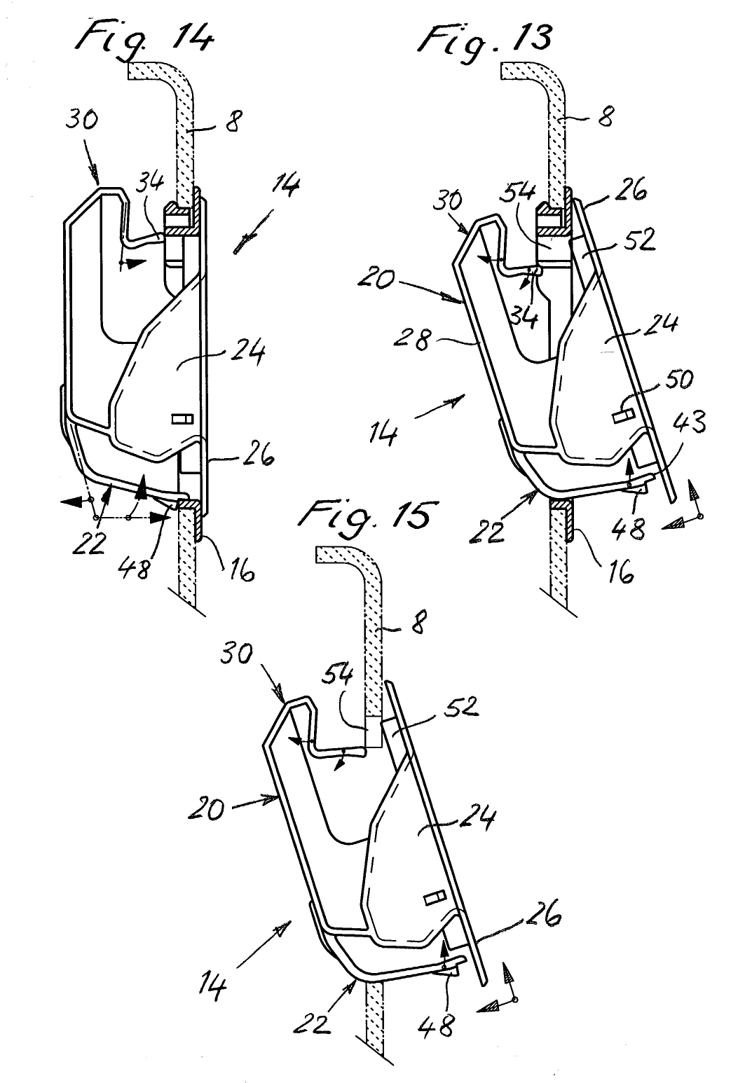

For mounting the frame 16 into the opening 12 of the pivoting cover 8, the elongated snapping member 66 of the frame 16 is initially inserted into the front end of the opening 12 of the pivoting cover 8, and thereafter the frame 16 is snapped into engagement with the hooks 64 by manually pressing against the rear end of the frame (see FIGS. 11 and 12). Inclined surfaces 76 of the hooks 64 facilitate insertion of the frame 16 into the opening 12. The arrows in FIG. 11 are intended to indicate the snapping movement of the rear end of the frame 16.

With reference to FIGS. 13 and 14, the mounting of the slidable closure 14 in the frame 16 will now be described. The slidable closure 14 is being inserted into the opening 18 of the frame 16 as shown until the flange 16 will engage the external side of the frame 16. At the same time the central guiding web 52 is being inserted into the guiding groove 54 of the frame 16 so as to provide for guidance of the slidable closure 14 during the further mounting operation. A slight manual push upon the flange 16 at the rear end of the slidable closure 14 will snap the latter into the end position shown in FIG. 14. As a result thereof the spring member 22 is resiliently deformed such that the lugs 48 slide past the frame 16 into their support positions. At the same time the catch 30 is resiliently deformed such that the free end portion slides along the internal edge of the web 62 of the frame 16 until it resiliently engages the internal surface of the frame 16. More precisely, the free end portion 34 of the catch 30 engages upon the web portions 72 and the web portion 74 defining the guide groove 54. The movements to be performed by the respective parts during the mounting of the slidable closure 14 are indicated by respective arrows in FIG. 13. The arrows in FIG. 14 at the spring member 22 and the catch 30 indicate the direction of the action of the respective resiliently biassed elements.

The frame 16 is not necessary for the mounting of the slidable closure 14. It is being used for example when the surface of the pivoting cover 8 which may be covered by felt or the like has friction characteristics which do not enable proper operation of the slidable closure. The plastic contact surfaces between the frame 16 and the slidable closure 14 will then provide for improved sliding characteristics. A frame about the slidable closure may also be desirable for esthetic reasons.

If, however, a frame is not desired for the above reasons, the slidable closure 14 may be mounted directly into the opening 12 of the pivoting cover 8. This is shown in FIG. 15. It should be readily apparent that the shape and dimensions of the opening 12 will have to be chosen such that they allow for proper mounting of the slidable closure 14. In particular, the front edge of the opening 12 must be provided with a guiding groove 54 for receiving the guiding web 52.

The operation of the slidable closure will now be described. When the slidable closure has been mounted to the pivoting cover 8 directly or via the frame 16 in the manner as set forth above, the slidable closure has its front and rear ends resiliently supported against the pivoting cover 8 via the spring member 22 and the catch 30 so as to be retained to the pivoting cover 8 without play. Furthermore, the spring member 22 will be deformed during assembly such that it exerts upon the closure member 20 a biassing force which biasses the closure member 20 towards its closing position (FIG. 1). When the closure member is in the closing position, the locking portion 32 of the catch 30 engages behind the retaining tongue at the wall 4 of the storing compartment 2. As a result thereof, the pivoting cover 8 is being retained in its closing position.

In order to displace the slidable closure 14 from its closing position (FIG. 1) to its opening position (FIG. 2) the closure member 20 is being slidably displaced relative to the fixed support of the spring member 22 in the longitudinal direction by fingers of a hand engaging the gripping portion 24. As a result thereof the flange 26 slides along the external surface of the frame 16 or, respectively, the external surface of the pivoting cover 8, and the free end portion 34 of the catch 30 slides along the other side of the frame 16 or, respectively, pivoting cover 8, with the slidable closure being guided so as to be prevented from moving transversely to the wall 8. The “three-point-bearing” comprised of the two guiding projections 50 and the central guiding web 52 within the guiding groove 54 prevents the closure member 20 from moving in lateral directions.

During the above movement of the slidable closure towards its opening position the spring memer 22 will be resiliently deformed as may be seen from a comparison of FIGS. 1 and 2. Due to the geometrical shape of the two leg portions 44 and 48 of the spring member 22 the two leg portions while being resiliently deformed are pivoted relative to each other such that the angle included between the two leg portions 44, 46 will be decreased. In other words, during resilient deformeation of the spring member 22 the leg portion 46 is pivoted counter-clockwise about the fixed support at the free end 43 thereof while the leg portion 44 is pivoted clockwise about a hinge axis provided by the transition between the connecting portion 28 and the leg portion 44. As a result the leg portion 46 can perform not only pivoting movements but also movements transverse to the longitudinal direction so that the closure member 20 during its entire longitudinal displacement will be perfectly guided so as to be prevented from moving transverse to the wall 8. Due to the selected thickness of the leg portions 44, 46 as drescribed and the outwardly converging width of the leg portion 46 of the spring member 22 the spring member 22 will be subjected to substantially uniform bending stressess during its resilient deformation.

Longitudinal displacements of the closure member 20 in the opening direction are limited by the central web 56. When the slidable closure 14 has reached its opening position, the pivoting cover 8 may be pivoted outwards by the hand engaging into the gripping portion (FIG. 2). When the closure member 20 is in this position it has been displaced far enough to enable the catch 30 to move past the retaining tongue 6.

For closing both the pivoting cover 8 and the slidable closure 14 all that is necessary is to move the pivoting cover 8 in the closing direction (to the left in FIG. 2). During such movement the cam surface 36 of the locking portion 30 will engage and slide along the retaining tongue 6. As a result thereof the catch 30 and therefor the entire closure member 20 are being displaced to their opening position. The catch 30 can now be moved past the retaining tongue 6. The biassed spring member will cause the catch 30 to snap behind the retaining tongue 6, with the cam surface 38 of the catch 30 providing for a smooth snapping action. The slidable closure 14 will then be again in its closing position (FIG. 1) so as to retain the pivoting cover 8 in its locked condition.

What is claimed is:

1. A slidable closure for a pivoting cover of a storing compartment in a vehicle, comprising:
a) a closure member comprising
a gripping portion for actuating the slidable closure,
a catch integral with said gripping portion,
a flange integral with said gripping portion, and
b) a resiliently deformable spring member having an end integral with said closure member and an opposite free end adapted to be fixedly supported at said pivoting cover,
c) said closure member and said spring member being an integral one-piece member which when mounted to said pivoting cover is slidably guided within an opening of said pivoting cover by said flange slidably engaging said pivoting cover on one side thereof and said catch and said spring member being resiliently supported against said pivoting cover on an opposite side thereof, such that said closure member is displaceable in a longitudinal direction relative to said fixedly supported free end of said spring member between a closing position wherein said catch engages behind a retaining tongue at a fixed wall of said storing compartment and an opening position wherein said catch is adapted to be moved past said retaining tongue for opening said pivoting cover, with said spring member being resiliently deformed as a result of such displacement of said closure member.

2. The slidable closure of claim 1, wherein said spring member when the slidably clossure is mounted to said pivoting cover is loaded such that it biases said closure member towards it closing position.

3. The slidable closure of claim 1, wherein said closure member has a pair of guiding projections slidably engaging lateral edges of said opening, and a central guiding web slidably guided within a guiding groove at a transversely extending edge of said opening, in order to prevent lateral movements of said closure member.

4. The slidable closure of claim 3, wherein said guiding web of said closure member forms an abutment for limiting displacements of said closure member in said longitudinal direction towards said closing position.

5. The slidable closure of claim 3, wherein said closure member has, on a side remote from said guiding web, a central rib forming an abutment for limiting displacements of said closure member in said longitudinal direction towards said opening position.

6. The slidable closure of claim 1, wherein said gripping portion and said catch are integrally connected to each other by a longitudinally extending connecting portion integral with said spring member.

7. The slidable closure of claim 6, wherein said connecting portion comprises a wall which is parallel to said flange and a web extending transversely thereto, with said wall and said web being integral with said gripping portion.

8. The closure member of claim 6, wherein said catch comprises an arcuate locking portion integral with said connecting portion and a free end portion extending transversely thereto, which end portion slidably engages an associated surface of said pivoting cover.

9. The slidable closure of claim 8, wherein said locking portion of said catch has opposite sides each provided with an inclined cam surface which slides along said holding tongue when said pivoting cover is being closed.

10. The slidable closure of claim 1, wherein said gripping portion is formed as a trough-shaped grip which is recessed to facilitate engagement by fingers of a hand.

11. The slidable closure of claim 6, wherein said spring member comprises a spring blade which is inclined with respect to said connecting portion.

12. The slidable closure of claim 11, wherein said spring blade comprises a first leg portion integral with said connecting portion and a second leg portion integral with said first leg portion by a radiussed portion, said first and second leg portions being inclined with respect to said connecting portion under different angles such that said spring member is deformable in a lateral direction additional to being deformable in said longitudinal direction.

13. The slidable closure of claim 12, wherein, for compensating for varying bending stresses in said spring member, said first leg portion is of a greater thickness than said second leg portion and/or said second leg portion is of a width decreasing towards said free end of said spring member.

14. The slidable closure of claim 1, wherein said spring member has a pair of lugs adjacent its free end to fixedly support and center said spring member adjacent an edge of said opening of said pivoting cover.

15. The slidable closure of claim 6, wherein stiffening ribs are provided in an area where said spring member and said connecting portion are connected to each other.

16. The slidable closure of claim 1, wherein said integral one-piece-member comprising said closure member and said spring member is a casting of an impact resistant, resiliently deformable plastic material.

17. The slidable closure of claim 1, wherein said integral one-piece-member comprising said closure member and said spring member is adapted to be inserted directly into said opening of said pivoting cover.

18. The slidable closure of claim 1, wherein there is provided a frame adapted to be inserted into said opening of said pivoting cover by snapping means, said frame having an opening designed and dimensioned such as to matingly receive said integral one-piece-member comprising said closure member and said spring member.

19. The slidable closure of claim 18, wherein said snapping means comprises a pair of hooks provided on one side of said opening of said frame and a resilient elongated snapping member provided on an opposite side of said opening of said frame.

20. The slidable closure of claim 19, wherein said frame has lateral edges provided with dimples to be press-fit into said opening of said pivoting cover.
